(19) United States
(12) Patent Application Publication
(10) Pub. No.: US 2018/0184634 A1
(43) Pub. Date: Jul. 5, 2018

(54) INSECT CONTROL DEVICE

(71) Applicants: Novelty Manufacturing Co., Lancaster, PA (US); Evarcha LLC, Gardiner, NY (US)

(72) Inventors: Joseph David DiMeo, Lititz, PA (US); Barry Alan Lebost, Gardiner, NY (US); Herbert Theodore Barnard, Lancaster, PA (US); Daniel Jonathan Lebost, Palm Beach Gardens, FL (US)

(73) Assignees: Novelty Manufacturing Co., Lancaster, PA (US); Evarcha LLC, Gardiner, NY (US)

(21) Appl. No.: 15/398,247

(22) Filed: Jan. 4, 2017

(51) Int. Cl. A01M 1/14; A01M 1/02; A01M 1/10

(52) U.S. Cl. CPC A01M 1/14; A01M 1/106; A01M 1/02

(57) ABSTRACT

An insect control device that lures and traps insects. The device has a fluid retaining vessel and a grille structure with opposed surfaces that are coated with a non-drying adhesive. The grille structure has openings that are dimensioned in relationship to the body size of a target insect. Coating both of the opposed surfaces of the grille provides an initial capture surface when an insect makes minimum contact with the grille and a secondary capture surface if an egg develops into a mosquito.

### FIELD OF INVENTION

The present invention relates generally to controlling airborne insects; it relates more specifically to insects having stings or bites that may transmit neurological problems or diseases, and it relates mostly specifically to the eradication of mosquitos.

### BACKGROUND

The presence of undesirable insects is a significant problem in many areas of the world. Insects such as mosquitoes and flies carry diseases, like Zika, that pass to humans, through a sting or bite, with devastating effects. As a general matter, standing water is a mosquito breeding ground. In many environments, the insect population is not limited to the outdoors because building construction techniques and barriers, like window and door screens are not always available or common.

With respect to mosquitoes in particular, the female mosquito generally lays her eggs over a fluid, like water, where the eggs sink and develop into larva. The larva develops into pupa and the pupas eventually emerge as adult mosquitoes.

Accordingly, there has been a concentrated effort to attack the insects at their breeding sites regardless of the locations. Some of these efforts have employed chemical agents to attract or kill the insects. However, many of the chemical agents have adverse or undesirable environmental or health side effects. In some regions where Zika, malaria or West Nile are present, there are many active efforts, like aerial spraying with its own attended health hazards, and there have been passive efforts to control the insect population at their breeding sites with solution such as those described in U.S. Pat. No. 8,181,384. While these solutions have had some effect, there is still a need for passive solutions that address indigenous breeding grounds, such as trash and abandoned tires, and has applicability to uses within and without habitats. In addition, it is desirable to interrupt the life cycle by reducing or eliminating the number of eggs that produce free flying mosquitoes.

### SUMMARY

One solution to the above need is to provide a vessel having a fluid reservoir, an evaporation portion and an insect capture grille. The insect capture grille is coated with a non-drying adhesive. The grille is positioned in an opening of a container between an evaporating fluid and the atmosphere so the moisturized air flows through the grille. Another solution is to use waste items, like old or abandoned tires, as the fluid reservoir and provide a coated insect capture grille for attachment to the waste device.

These oviposition traps can be strategically placed to potentially reduce the spread of disease. By placing traps in the proximity of individuals who may potentially be carrying Zika, chikungunya, dengue or yellow fever, health care professionals or family members may potentially reduce the spread of infection to others nearby by capturing the post blood meal mosquitoes that have bitten an ill person. This can reduce the likelihood of a potentially infinite chain of disease progression that each newly infected mosquito has the capability of starting.

The present solution is “passive” because it eliminates the insects without harmful pesticides and does not require an external energy source. The present invention's grille structure with non-drying adhesive also captures eggs or emerging mosquitoes in addition to capturing egg laying females.

### BRIEF DESCRIPTION OF THE DRAWING(S)

FIG. 1 is a perspective view of one embodiment of an insect capture grille;

FIG. 2 is sectional view along the line 2-2 in FIG. 1;

FIG. 3 is a sectional view along the line 3-3 in FIG. 1;

FIG. 4 is sectional view, similar to FIG. 3, illustrating another embodiment of an insect capture grille;

FIG. 5 illustrates one embodiment of a fluid reservoir vessel with an installed grille;

FIG. 6 is a section along the line 6-6 in FIG. 5; illustrates the fluid reservoir vessel of FIG. 5 with an exposed grille;

FIG. 7 illustrates the fluid reservoir vessel of FIG. 5 with an installed grille and an optional cover that partially encloses the open end of the vessel;

FIG. 8 illustrates another embodiment of a fluid reservoir vessel with an installed grille;

FIG. 9 is a section along the line 8-8 in FIG. 8;

FIG. 10 illustrates the fluid reservoir vessel of FIG. 8 with an installed grille and an optional cover that partially encloses the open end of the vessel;

FIG. 11 illustrates a preferred assembly with the preferred locations for evaporation or venting openings.

FIG. 12 is an exploded view that illustrates the use of a grille with an available fluid vessel, such as a tire;

FIG. 12 A illustrates an assembly of the parts illustrated in FIG. 11 that is particularly useful for placement on a horizontal surface;

FIG. 13 is an exploded view that illustrates the use of multiple grilles with an available fluid vessel, such as a tire; and,

FIG. 13 A illustrates an assembly of the parts illustrated in FIG. 13 that is particularly useful for placement in a vertical position.

### DETAILED DESCRIPTION OF THE PREFERRED EMBODIMENTS

In the following description, terms like interior, exterior, upper, and lower are made with reference to the drawing figures for ease of explanation and are not limitations on the orientation of any component relative to another component. The following description will use the mosquito as an exemplary insect; however, it will be appreciated that certain features of the invention may be adjusted if the target insect is different than the exemplary mosquito. The literature suggests that an adult Aedes aegypti mosquito ranges in size from a low of about 1.7 mm to a high of about 7.0 mm.

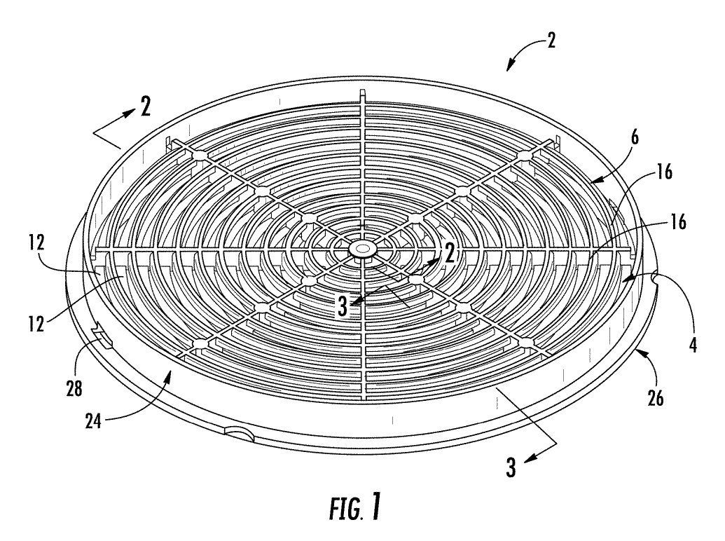

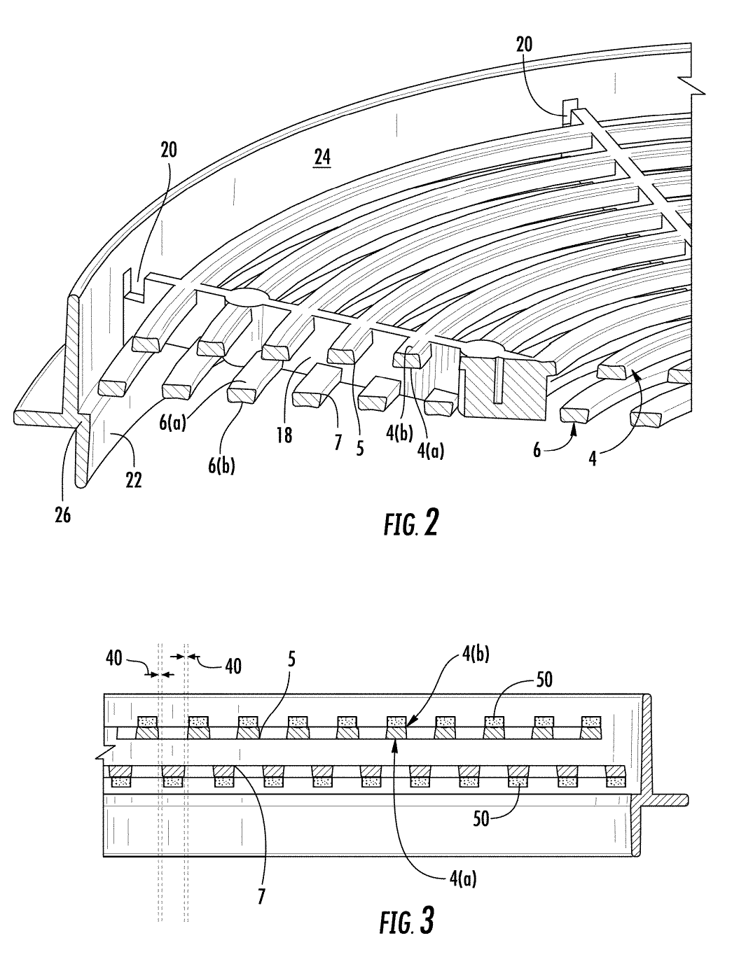

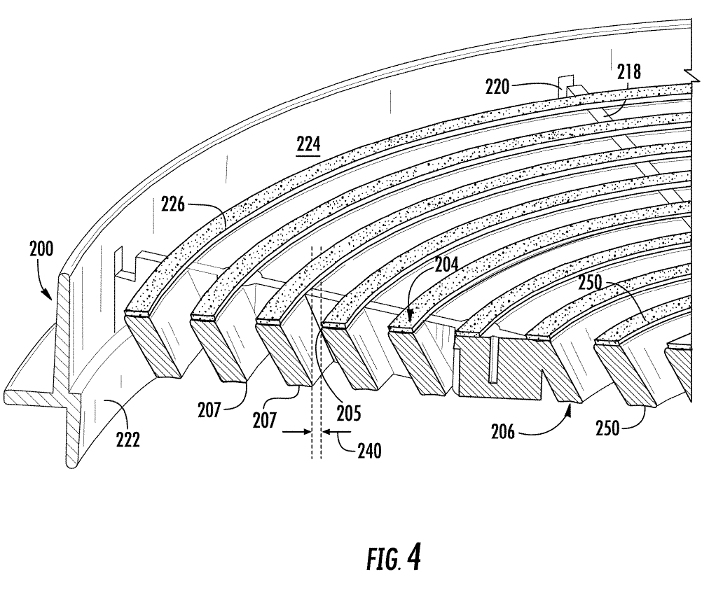

With reference to FIG. 1, the insect capture grille 2 is an open structure that has an interior or lower surface 4 and an exterior or upper surface 6. The grille structure openings are dimensioned in relationship to the target mosquito's body size of between about 1.7 mm to about 7.0 mm. In this embodiment, surface 4 is comprised of concentric rings 12 and surface 6 is comprised of concentric rings 16. As will be seen with reference to FIG. 2, the concentric rings of surfaces 4 and 6 in this configuration are independent from each other and a plurality of radially extending ribs 18 supports the concentric ribs. The ribs 18 have notches 20 that are sized to fit over the rim of a fluid containing vessel. The rings 12 of surface 4 have an interior face 4 (a) and an exterior face 4 (b). The rings 16 of surface 6 have an interior face 6 (a) and an exterior face 6 (b). The concentric rings 12 and 16 of surfaces 4 and 6 are horizontally off set from each other so that the vertical path of ingress or egress past the two surfaces is not a straight line or linear. In other words, passing inwardly or outwardly past the surfaces 4 and 6 requires travel in a non-linear path.

Still with reference to FIG. 1, grille 2 preferably has several slots or openings 28 that are positioned to permit air flow and drainage above the lip 26, 226.

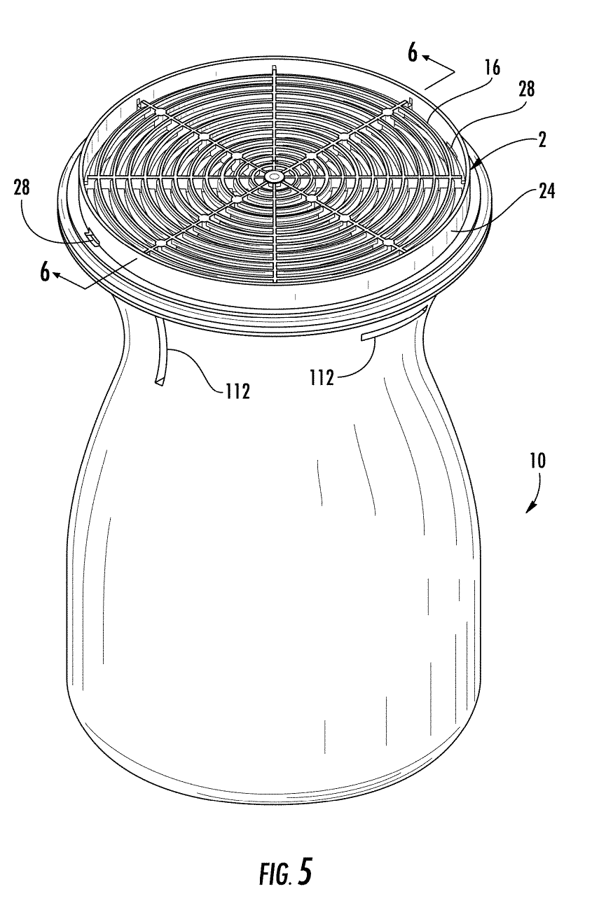

FIG. 3 further illustrates the non-linear arrangement of the concentric rings 12 and 16. The respective sides of the alternating concentric rings 12 and 16 have interior surfaces 5 and 7 with edges that are horizontally spaced, see 40, by between 1.7 mm and 4.0 mm with a range of about 2.0 mm to about 3.0 mm being preferred and about 2.5 mm being most preferred. This clearance 40 is small enough that it does not allow the insect a linear path between rings and it is useful in the molding technique employed to produce the grille 2 as a single unit or unified part that does not require further assembly. Additionally, the sides of the concentric rings 12 and 16 taper from the interior surfaces 4 (a) and 6 (b) to the exterior surfaces to provide a slightly wider entrance for the insects and a tolerance for a tooling draw.

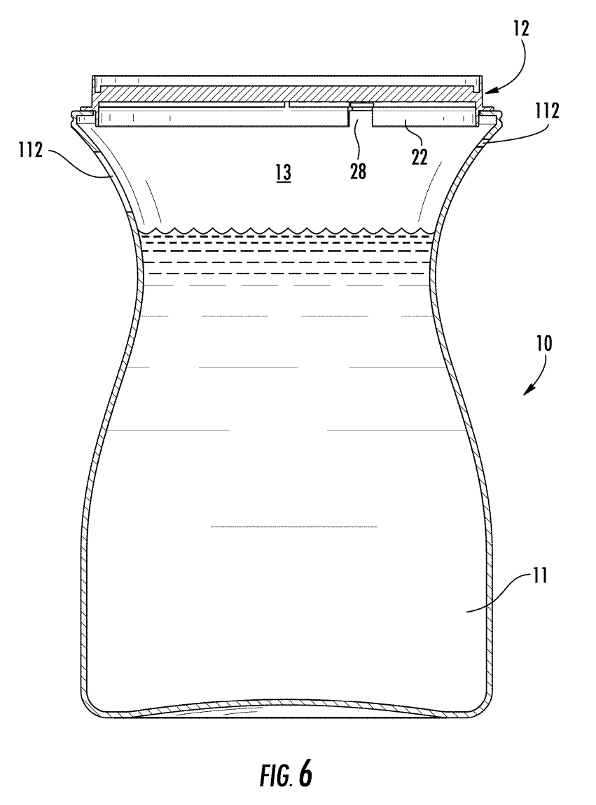

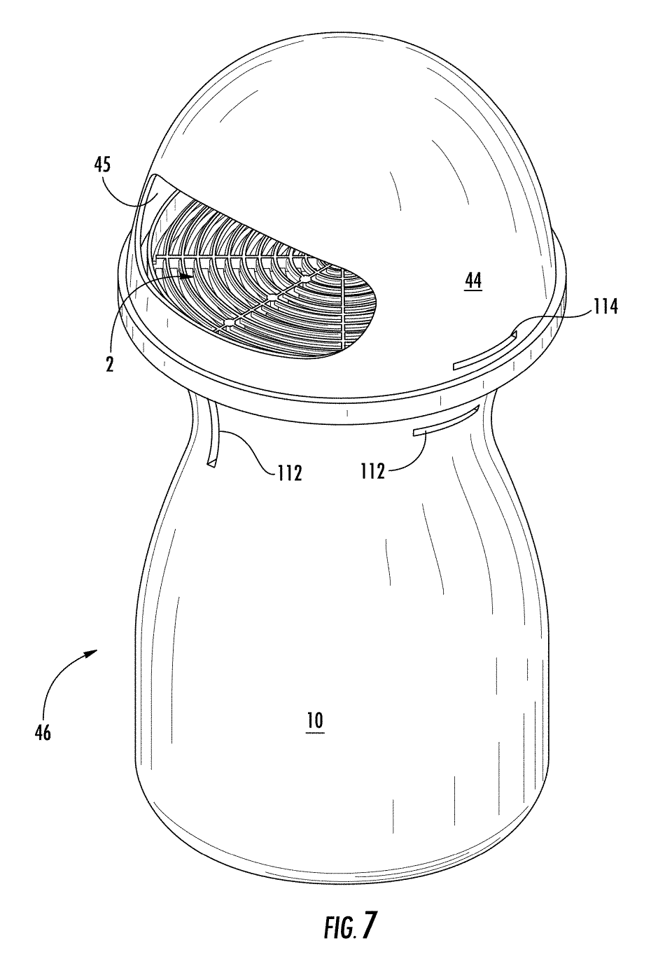

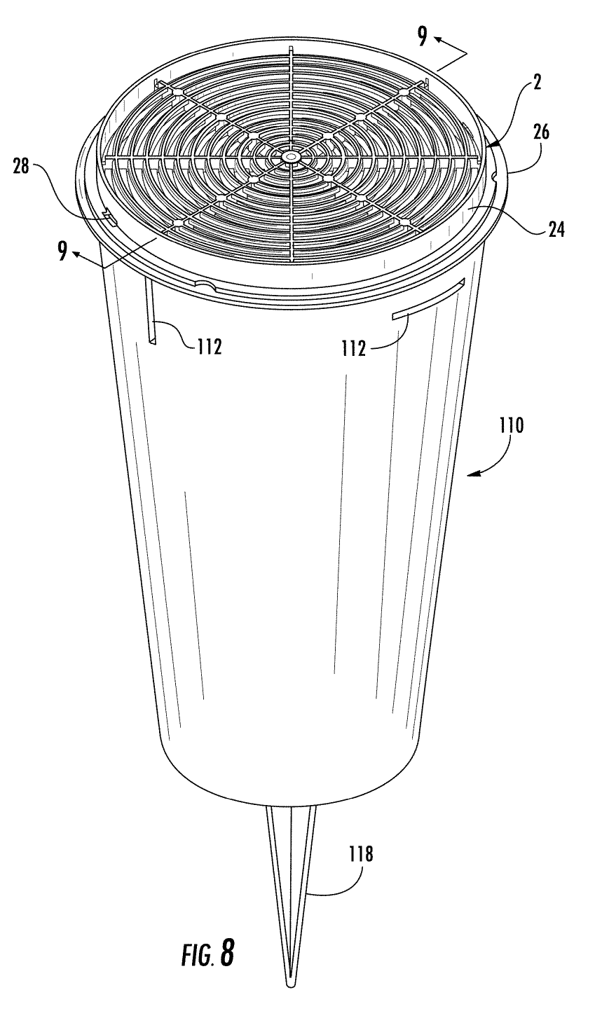

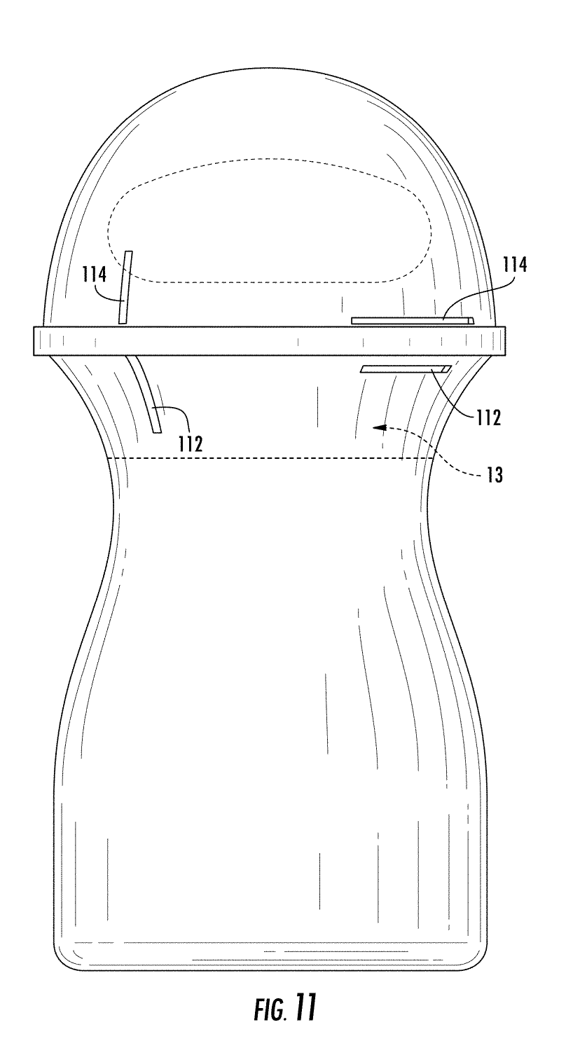

The grille 2 is preferably circular to mate with a complementarily sized circular rim on a fluid containing vessel, see FIGS. 5-10, because a circular grille with a complementarily sized circular rim guards against the grille 2 accidently falling into the vessel. However, other grille shapes are possible so long as they have surface coatings of non-drying adhesive and provide a path between surfaces that urge the insect into contact with the insect capture grille. One advantage to having the non-drying adhesive 50 and 250, see FIGS. 3 and 4, on both surfaces is the increased possibility of capturing an insect that somehow passes the ingress surface on egress or capturing a larvae or juvenile insect that hatches from an egg that passes into the vessel without being captured on the non-drying adhesive.

FIG. 4 illustrates an alternative grille configuration 200 that has an interior lower surface 204 and an exterior upper surface 206. In this embodiment, connected concentric rings are a single structure that is angled with respect to its surrounding structure, 24 and 224, to create a restricted non-linear path between the surfaces 204 and 206. The plurality of radially extending support ribs 218 have notches 220. The clearance 240 between the edges 205 and 207 is again between 2.0 mm and 4.0 mm with the 2.5 mm being preferred.

In the configuration illustrated in FIGS. 1-4, a perimeter wall surrounds the lower and upper surfaces 4, 6, 204 and 206. The surrounding parameter has a lower section 22, 222, an upper section 24, 224, and a lip 26, 226. In the preferred embodiments, the insect capture grille fits within the rim of a fluid containing vessel and the lip, 26 or 226, rests on the top of the vessel, see FIGS. 5-10. This results in the upper portion extending above the vessel and provides a gripping area so a user can insert and remove the grille without contacting the non-drying adhesive.

A suitable non-drying adhesive for use with the grille 2 is a polybutene sold as Tangle-Trap Paste Item #9500 by Tanglefoot Acquisitions, Inc., 314 Straight Ave SW, Grand Rapids, Mich. 49504.

With reference to FIGS. 3 and 4, a non-drying adhesive 50 and 250 preferably is applied to only the interior and exterior surfaces 4, 6, 204 and 206 of the grille 2 and 200. This targeted application keeps the adhesive material from getting into and between the exposed surfaces, and avoids the tendency of an interior application to restrict the airflow associated with evaporation of the fluid. It also avoids application to the outer portions of the perimeter wall. The upper section 24 of the perimeter wall will be beneficial to a user who is positioning a grille on a container. Because the non-drying adhesive is very tacky and tends to stick to a user, similar to fly paper, the upper section and the lip 26 provide gripping points that are free of the non-drying adhesive. As a result, the grille can be installed, removed and replaced without touching the non-drying adhesive or insects captured by it.

As can be seen from the above, the grille structure's upper surface will initially capture the adult mosquito and possibly any eggs that are laid. If eggs pass through the grille structure to the liquid beneath the grille, any emerging mosquitoes are subject to being captured by the lower surface of the grille. Hence, the grille structure provides a capture surface in both directions.

With reference to FIGS. 5-7, the preferred container 10 is preferably blow molded of standard polymers, such as high density polyethylene, low density polyethylene, polypropylene, poly vinyl chloride, polyethylene, polycarbonate, acrylonitrile copolymer or polyethylene terephthalate used in blow-molding processes. As shown in FIGS. 5 through 11, the container body has one or more horizontal or vertical openings 112 for evaporation or venting. More preferably, there are at least three openings 112 equally spaced about the container body in an area above the liquid or water line. For the adult Aedes aegypti mosquito, the openings are between 2.0 mm and 4.0 mm with the 2.5 mm being preferred. The size of the openings 112 can be adjusted according to the target insect, the container size and the fill line. As illustrated in FIGS. 5 through 11, an evaporating liquid or fluid 11 is provided to a maximum fill line that preserves open space or an evaporation area 13 where the openings 112 are located.

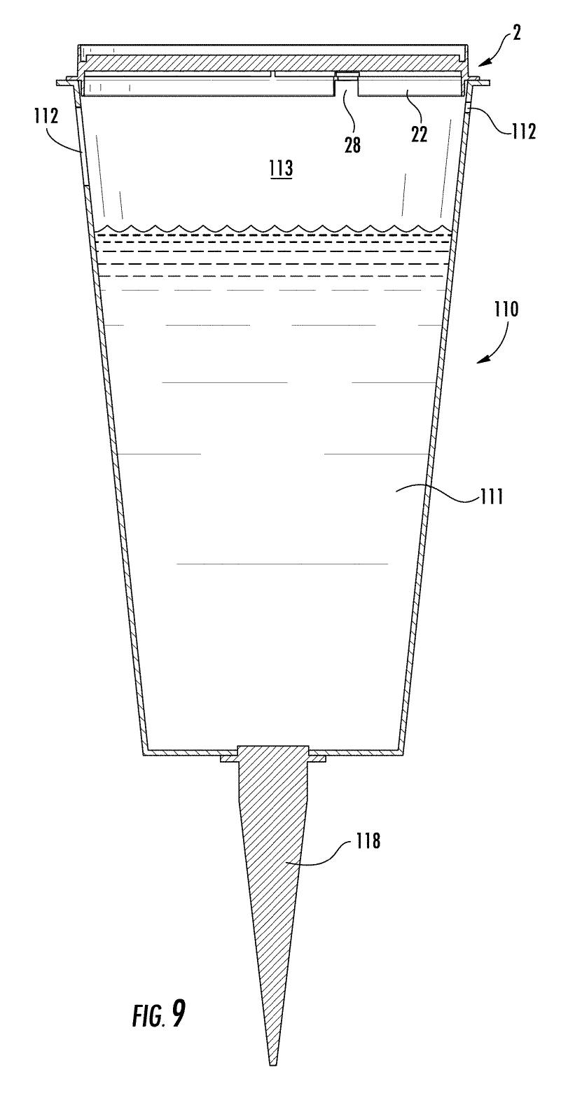

With reference to FIG. 7, the illustrated embodiment has a base 10 and a cover 44 which are matched to create an assemble 46. The cover 44 has an aperture 45 that provides ingress for an insect to enter the assembly 46. The cover is useful because there is some evidence that insects prefer a darkened nesting site and black is a preferred color. In this configuration, the cover 44 has an aperture 45, to attract insects through evaporation and provide ingress to the grille 2, and at least one horizontal or vertical opening 114. If desired, the assembly 46 can include a container with openings 112 and a cover with openings 114. As illustrated in FIG. 11, the openings 114 are space about the centerline in a surface opposite the aperture 45. Also, as shown in FIG. 11, a combination of opening may be used in the same assembly and they can be spaced to achieve different evaporation patterns.

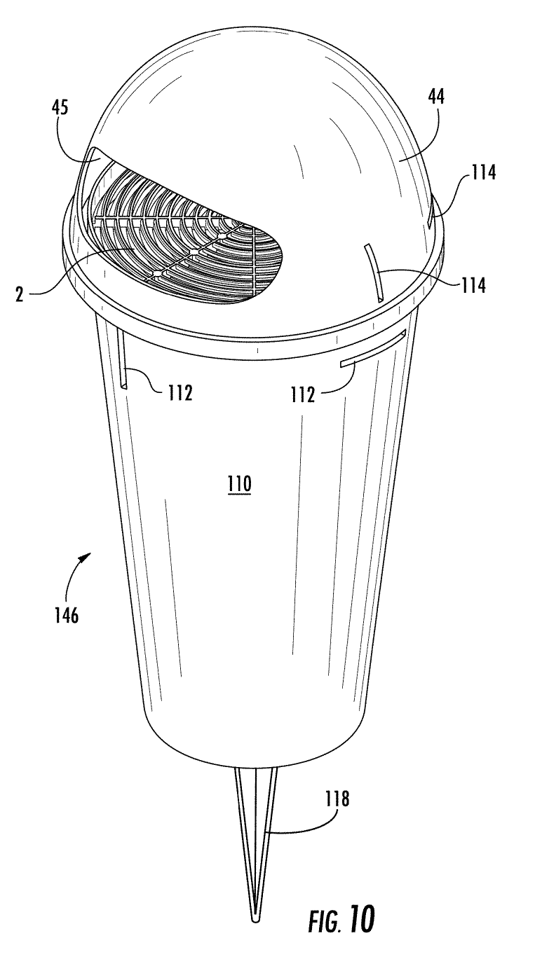

With reference to FIGS. 8-10, the vessel 110 in this embodiment is preferably injection molded of standard polymers, such as high density polyethylene, low density polyethylene, polypropylene, poly vinyl chloride, polyethylene, polycarbonate, acrylonitrile copolymer or polyethylene terephthalate. As illustrated in FIGS. 8-10, this embodiment 110 has an optional stake 118 for securing it to a penetrable surface, such as soil or gravel, to prevent it from tipping over. The embodiments illustrated in FIGS. 8 and 10 are similar to those in FIGS. 5 and 7, except for the shape of the vessel, and preferable include openings 112 and or 114 in accordance with the configuration of the device.

Although the covers illustrated in FIGS. 7 and 10 are the presently preferred dome shape, other shapes that provide partial coverage and free ingress to the grille 2 may be used according to the target application.

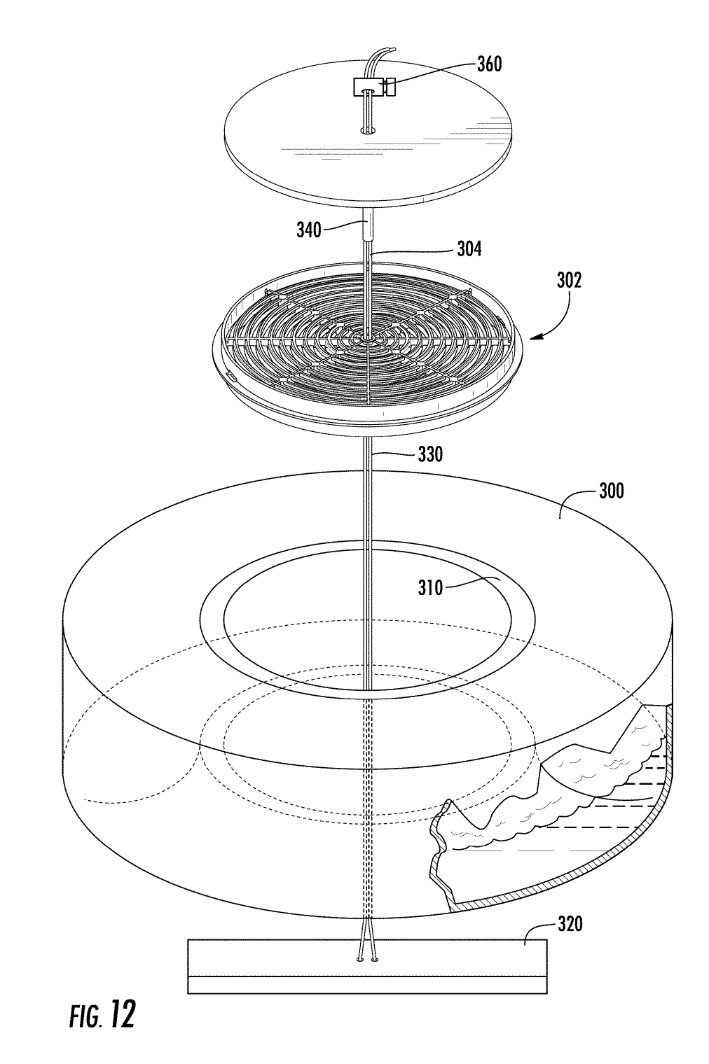

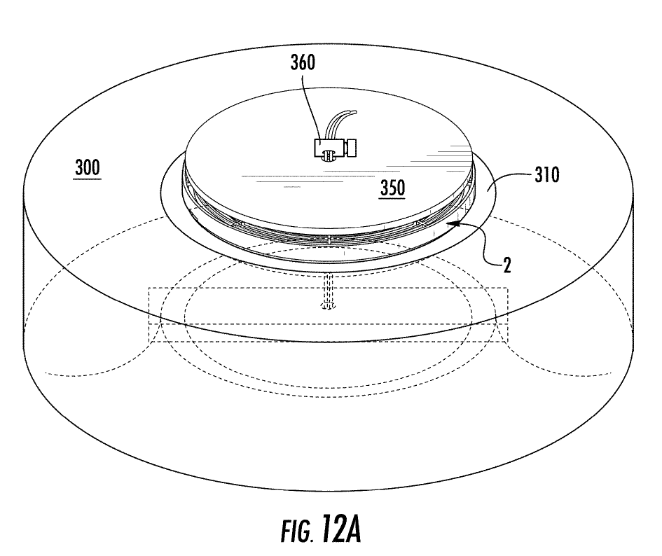

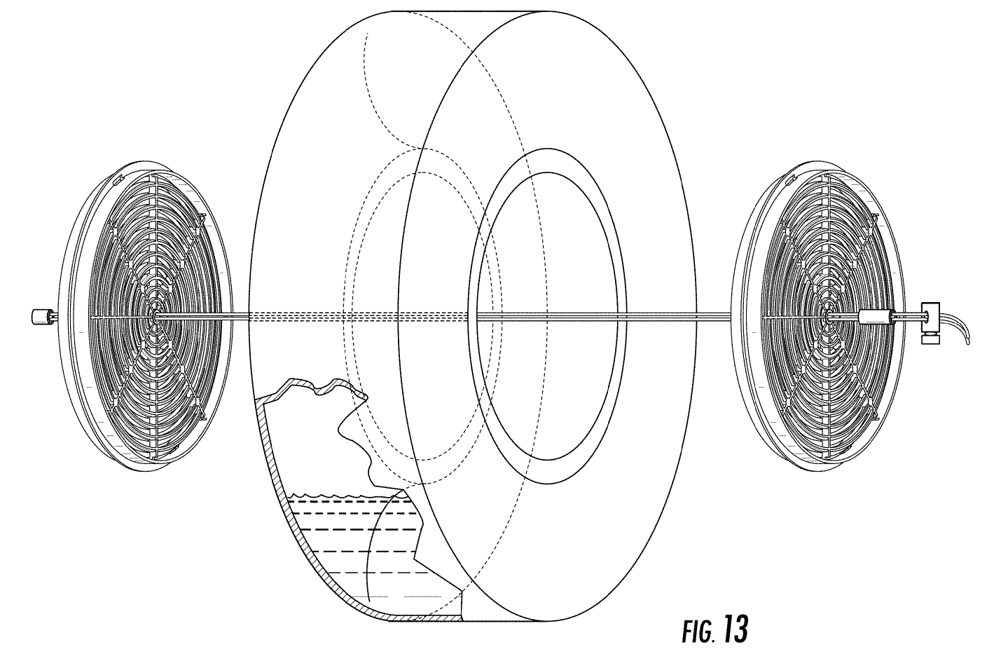

With reference to FIGS. 12 and 12 A, there is illustrated an example of using a grille 302 with an existing item, like tire 300, which is suitable for use in a horizontal placement. The grille 302 overlays the central opening 310 in tire 300 and has a central opening 304 through which a cord 330 passes. The cord 330 is connected to a stabilizer 320 that abuts a second opening 310 in tire 300. The cord length is adjusted with a common spring loaded cord toggle, so the cord can be opened and closed as needed. In this configuration, it is preferred to provide a standoff 340 and a cover 360. Standoff 340 spaces the cover 360 from the grille 302 so insect have access while the cover 360 guards against debris, such as leaves and air borne trash sticking to the non-drying adhesive. FIG. 12 A illustrates the assembled condition of the element in FIG. 12.

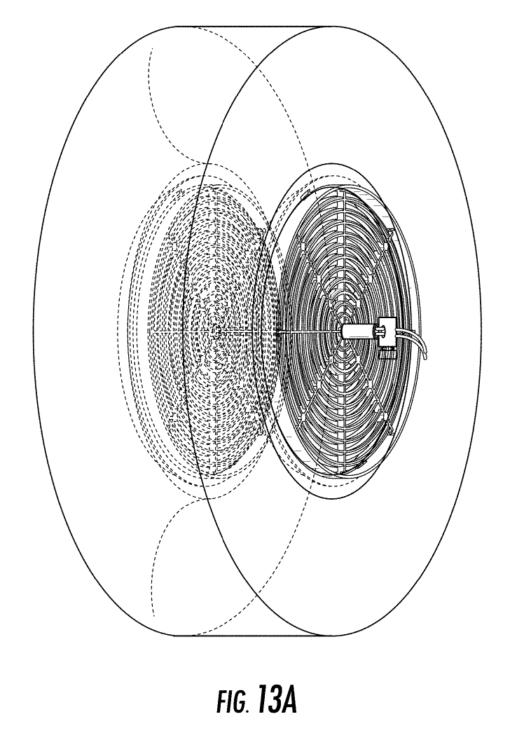

With reference to FIGS. 13 and 13 A, there is illustrated an example of using two grilles 302 with an existing item, like tire 300, which is suitable for use in a vertical placement. The grilles 302 overlays the central opening 310 in tire 300 and joined with cord 330. The cord 330 is connected to a standoff stabilizer 342 on both sides of tire 300. The cord length is adjusted with a common spring loaded cord toggle, so the cord can be opened and closed as needed. Depending on the specific application, covers 360 can be added to guard against debris, such as leaves and air borne trash sticking to the non-drying adhesive. FIG. 13 A illustrates the assembled condition of the elements in FIG. 13.

What is claimed is:

1. An insect control device for use with a fluid retaining body having at least one aperture, the insect control device comprising:
a grille with opposed surfaces and a perimeter that is configured to overlay an aperture in a fluid retaining body that is located between a retained fluid and a surrounding atmosphere and the opposed surfaces of the grille are coated with a non-drying adhesive.

2. The insect control device of claim 1, wherein each of the opposed grille surfaces is comprised of a plurality of openings that are offset from the plurality of openings in the opposed grille surface.

3. The insect control device of claim 1, wherein the opposed grille surfaces are independent surfaces and each of the opposed grille surfaces is comprised of a plurality of openings that are non-linear with respect to each other.

4. The insect control device of claim 1, wherein the grille has a structural array that connects the opposed surfaces.

5. The insect control device of claim 4, wherein the opposed surfaces are comprised of a plurality of openings that are non-linear with each other.

6. The insect control device of claim 1, wherein the grille has a circular perimeter.

7. The insect control device of claim 1, wherein each of the opposed grille surfaces is comprised of a plurality of openings that are of a predetermined dimension associated with a predetermined target insect.

8. An insect control device comprising:
an elongated body that includes a reservoir portion, an evaporation portion that is in communication with the reservoir portion and an external atmosphere, and an insect capture grille, wherein
the insect capture grille is an apertured structure that is coated with a non-drying adhesive and positioned on the elongated body so it is between the evaporation portion and the external atmosphere.

9. The insect control device of claim 8, wherein the elongated body includes at least one opening that is positioned in the evaporation portion.

10. The insect control device of claim 8, wherein the insect capture grille is comprised of the opposed grille surfaces and each grille surface is comprised of a plurality of apertures that are offset from the plurality of apertures in the opposed grille surface.

11. An insect control device comprising:
a body having a fluid retaining cavity and at least one opening; and,
an apertured structure that is dimensioned to overlay the at least one opening in a position between a fluid in the body and a surrounding atmosphere, and has first and second sides that are coated with a non-drying adhesive.

12. The insect control device of claim 11, wherein the body includes at least one opening located between the fluid retaining cavity and the apertured structure.

13. An insect capture insert for use with a fluid retaining body having at least one opening, the insect capture insert comprising:
a grille with first and second sides that are coated with a non-drying adhesive that is positioned between a fluid in a fluid retaining body and a surrounding atmosphere, and has at least one of the first and second sides exposed to the surrounding atmosphere.

14. An insect capture insert for use with a fluid retaining body having at least two spaced apart openings, the insect capture insert comprising:
a grille with first and second sides that are coated with a non-drying adhesive;
a stabilizer that overlies one of the at least two spaced apart openings in a fluid retaining body; and
a fastener that extends between the grille and the stabilizer;
whereby the grille is retained over another of the at least two spaced apart openings in a fluid retaining body in a position between a contained fluid and a surrounding atmosphere.

15. An insect capture device comprising:
a body having a fluid retaining portion and at least two openings that are spaced apart and opened to a surrounding atmosphere;
a grille with first and second sides that are coated with a non-drying adhesive;
a stabilizer that overlies one of the at least two openings; and
a fastener that extends between the grille and the stabilizer;
wherein the grille is positioned over another of the at least two openings and is between the fluid retaining portion and the surrounding atmosphere.

16. The insect capture device of claim 15 further comprising:
a cover that overlies at least a portion of the grille.

17. The insect capture device of claim 16 further comprising:
at least one spacer located between the grille and the cover.

18. The insect capture device of claim 17, wherein
the fastener passes through the at least one stabilizer and extends between the cover and the stabilizer.

19. The insect capture device of claim 15, wherein the body has a toroidal shape.

20. An insect capture device comprising:
a grille that has opposed surfaces coated with a non-drying adhesive and is dimensioned to overlie an aperture in a fluid retaining body in a position between a fluid in a fluid retaining body and a surrounding atmosphere.

21. The insect capture device of claim 20 wherein the grille further comprises a perimeter wall that extends vertically above and below the opposed surfaces and is free of the non-drying adhesive.

22. The insect capture device of claim 20, wherein the grille further comprises an outer perimeter wall and lip that extends outwardly from the wall.

23. The insect capture device of claim 20 further comprises a fluid retaining body that defines an aperture open to a surrounding atmosphere and is dimensioned to receive the grille in an overlying position.

24. The insect capture device of claim 23, wherein the fluid retaining body is generally circular.

25. The insect capture device of claim 23, wherein the fluid retaining body is generally conical.

26. The insect capture device of claim 23, wherein the fluid retaining body is generally toroidal.

27. An insect control device comprising:
a body having a fluid retaining cavity and at least one opening that exposes a retained fluid to a surrounding atmosphere; and,
an insect control structure interposed between the fluid retaining cavity and a surrounding atmosphere, the insect control structure has a plurality of apertures defined by a plurality of structural segments that are spaced apart by a predetermined spacing associated with a predetermined target insect and the plurality of structural segments are coated with a non-drying adhesive.

28. The insect control device of claim 27, wherein the body includes at least one second opening that is no greater in width than the predetermined spacing of the plurality of structural segments.

29. An insect control device comprising:
a body having a fluid retaining cavity and at least one opening to a surrounding atmosphere;
an insect control structure that is positioned between the fluid retaining cavity and a surrounding atmosphere, the insect control structure has a plurality of apertures defined by a plurality of spaced apart structural segments that are spaced apart by a predetermined dimension and coated with a non-drying adhesive; and,
an enclosure that partially encloses the at least one opening to a surrounding atmosphere and provides an aperture opened to the insect control structure.

30. The insect control device of claim 29, wherein the device includes at least one second opening of a second predetermined dimension that is no greater in width than the predetermined dimension of the plurality of structural segments.

31. The insect control device of claim 30 wherein the at least one second opening is located in the body above the fluid retaining cavity.

32. The insect control device of claim 30 wherein the at least one second opening is located in the enclosure.

33. The insect control device of claim 29, wherein the device includes at least two second openings of a second predetermined dimension that is no greater in width than the predetermined dimension of the plurality of structural segments.

34. The insect control device of claim 33, wherein one of the at least two second openings of a second predetermined dimension is located in the body and the other of the at least two second openings of a second predetermined dimension is located in the enclosure.

35. The insect control device of claim 29, wherein the device includes at least one second opening of a second predetermined dimension that is associated with a target insect.
